(19) United States
(12) Patent Application Publication
(10) Pub. No.: US 2022/0023680 A1
(43) Pub. Date: Jan. 27, 2022

(54) FACE SHIELD

(71) Applicants: Zhongtai Chen, Meridian, ID (US); Qing-Min Chen, Meridian, ID (US)

(72) Inventors: Zhongtai Chen, Meridian, ID (US); Qing-Min Chen, Meridian, ID (US)

(21) Appl. No.: 16/938,918

(22) Filed: Jul. 25, 2020

(51) Int. Cl. A62B 23/02; A62B 18/10; A62B 18/00

(52) U.S. Cl. CPC A62B 23/02; A41D 13/1138; A62B 18/006; A62B 18/10

(57) ABSTRACT

A face shield adapted to fit over a face of a user to cover a nose and mouth of the user. The face shield includes an exhale port, an attachment system to fasten the shield to the user, a fan insert receiver, and an air inlet opening connected to the fan insert receiver. A fan that attaches to the fan insert receiver. The fan includes a motor, fan blades attached to the motor and an air exit. The air exit of the fan is positioned to dump air from the air inlet opening into the area covered by the shield. An air filter is connected to the air inlet opening of the shield. An exhale valve is connected to the exhale port that allows waste air to exit the shield. There is a power source connected to the fan motor to run the fan.

### BACKGROUND

The present invention generally relates to face masks. More specifically, the present invention relates to a face mask that includes positive pressure and air filtrations in a portable fashion.

Traditionally people use porous face masks. Porous masks are by design difficult to use. If the wearer touches the outside of the mask, they are contaminated. These masks also require the user to inhale through clothe material, which can be difficult for those with respiratory issues, claustrophobia, or with any sort of strenuous activity. Some face masks use an air hose to deliver air from a purified source. Some face masks employ exhaling valves.

Typically, fan powered face masks use axial fans, which end up creating a low pressure system. To best combat microbes and other contaminates, there should be a strong, positive pressure associated with the face mask. This also makes the task of breathing much easier. Self-contained filtration devices are also necessary to minimize contamination. There is also no means on the market to purify air on exhalation.

It is an object of the present invention to provide a localized, wearable air purification device designed to create a positive pressure system to keep microbes and contaminates from reaching a wearers mucous membranes.

### SUMMARY

A face shield adapted to fit over a face of a user to cover a nose and mouth of the user. The face shield includes an exhale port, an attachment system to fasten the shield to the user, a fan insert receiver, and an air inlet opening connected to the fan insert receiver. A fan that attaches to the fan insert receiver. The fan includes a motor, fan blades attached to the motor and an air exit. The air exit of the fan is positioned to dump air from the air inlet opening into the area covered by the shield. An air filter is connected to the air inlet opening of the shield. An exhale valve is connected to the exhale port that allows waste air to exit the shield. There is a power source connected to the fan motor to run the fan.

### BRIEF DESCRIPTION OF DRAWINGS

FIG. 1 is a perspective view of a face shield according to the present invention.

FIG. 2 is a perspective view of a face shield according to the present invention.

FIG. 3 is a perspective view of a face shield according to the present invention.

FIG. 4 is an exploded perspective view of a face shield according to the present invention.

FIG. 5 is a perspective view of a shield according to the present invention.

FIG. 6 is a perspective view of a shield according to the present invention.

FIG. 7 is a perspective view of a fan according to the present invention.

FIG. 8 is a perspective view of a fan according to the present invention.

FIG. 9 is a schematic view of a valve according to the present invention

### DETAILED DESCRIPTION

The present invention is a face shield 10 that has positive pressure of inflow air and air filtration. The face shield also includes an ultraviolet (UV) sanitized exhale valve. The face shield minimizes the breathing of contaminated air, whether it is from allergens, microbes, or the like. The face shield is reusable and requires less sterilization than traditional face masks, as the outside contaminants only contact a HEPA filter. The HEPA filter is interchangeable. The face shield includes a fan for positive pressure airflow. Breathing air generated from a fan is much more comfortable long term than inhaling the air through a porous material. The air itself is always fresh, as opposed to breathing the same air within a standard face mask. The positive pressure generated by the fan will minimize any outside air coming into contact with the mucous membranes. For people that wear glasses, this face shield design will minimize fogging. The face shield also places the batteries, the heaviest part of the system, around the wearer's neck, as opposed to a headset system, for additional comfort. There are also no gaps between the face shield and the wearer's face. This is important because during deep inhalation, all the air will go through the filtration system, as opposed to unfiltered air around the mask. The exhale valve is also important to maintain a high flow rate.

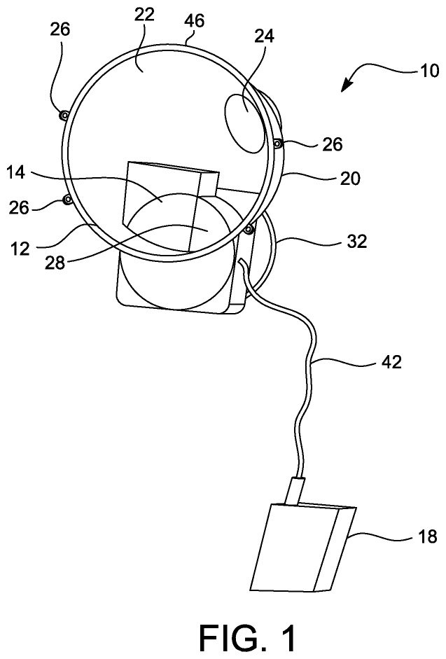

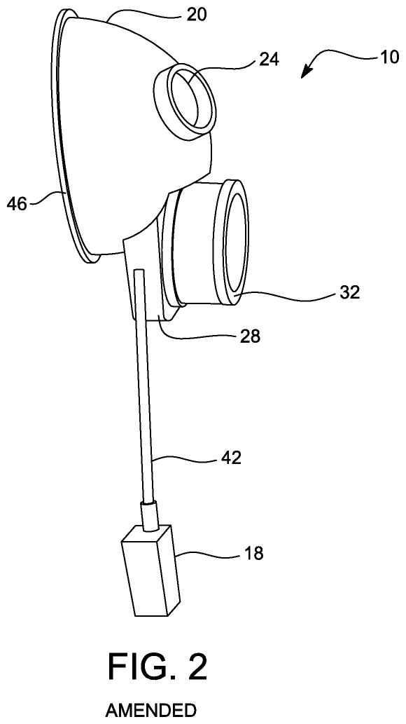

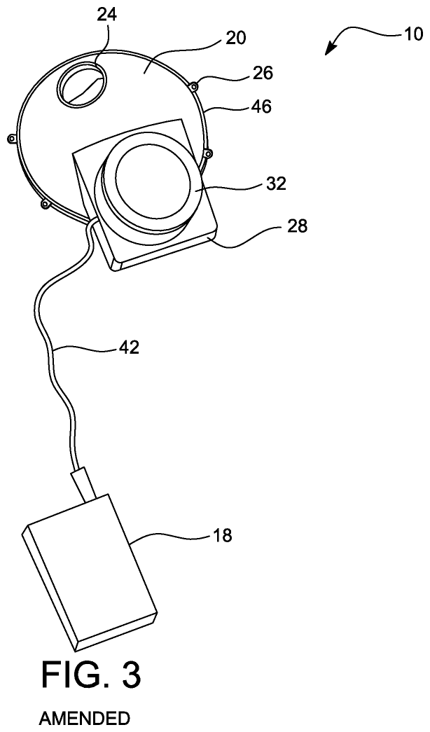

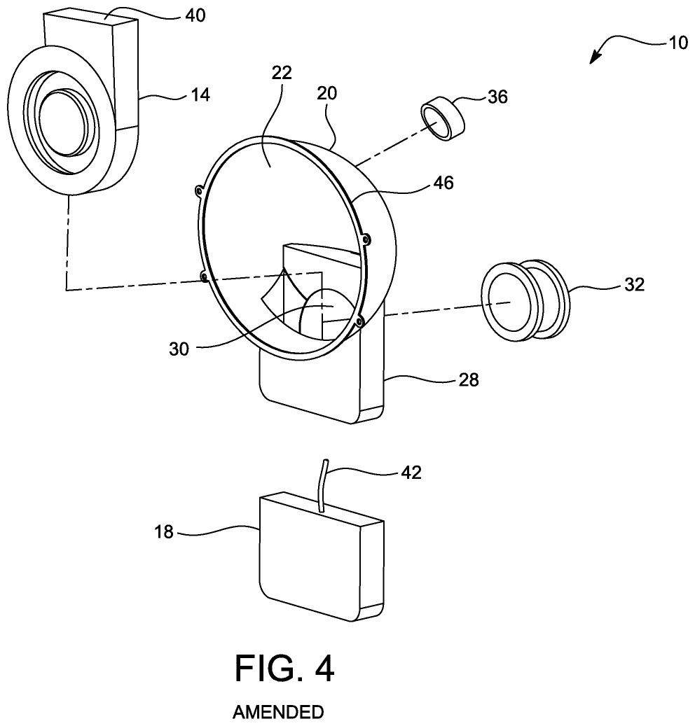

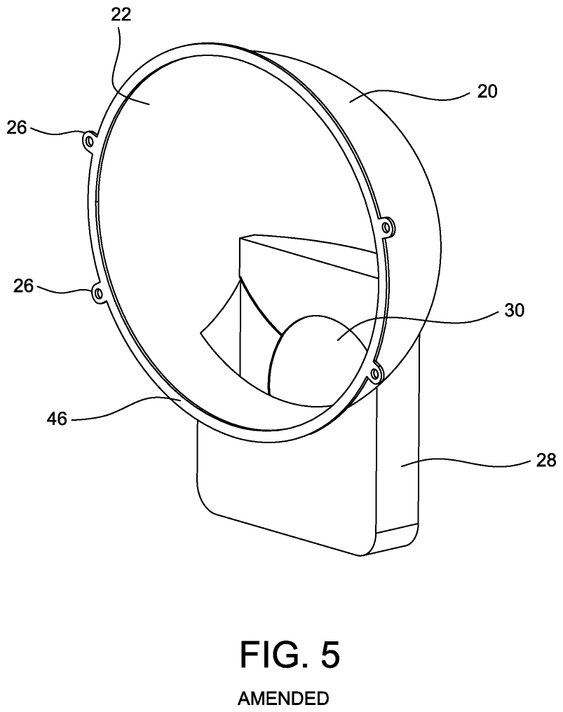

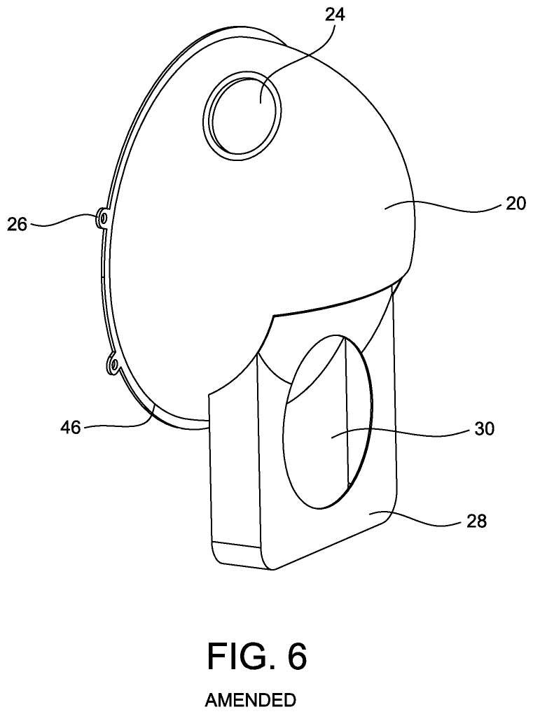

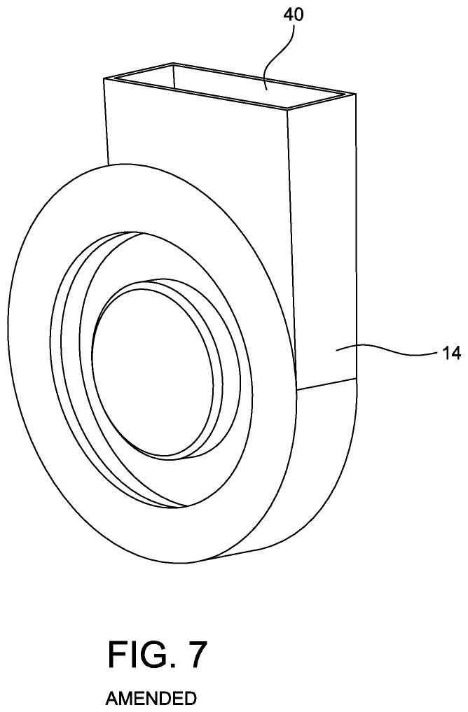

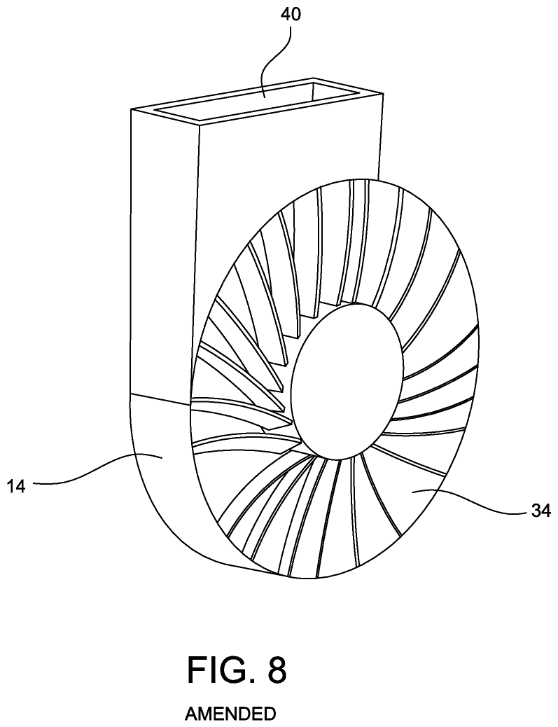

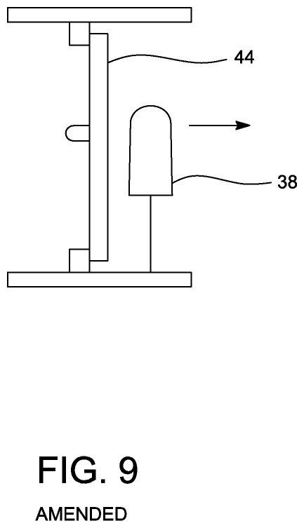

FIGS. 1-4 show the face shield 10 according to the present invention. The face shield 10 includes a shield 12, fan 14, and battery 18, as shown in FIGS. 1-4. The shield 12 has an outside surface 20 and an inside surface 22 that faces the user and covers part of the face of the user. The shield 12 is made of a nonporous material. The shield 12 includes an exhale port 24, strap ears 26 with holes and a fan insert receiver 28 having an inlet opening 30 as part of the shield 12, as shown in FIGS. 5-6. FIG. 4 also shows a HEPA filter 32 that connects to the shield 12 at the inlet opening 30, to act as an air filter for incoming air. The inlet opening 30 can be as wide as 500 mm². The fan 14 is shown in FIGS. 7-8, where fan blades 34 are shown in FIG. 8 of a centrifugal fan. The fan 14 includes a fan motor attached to the fan blades 34 to turn the fan blades 34. FIG. 9 shows a schematic of an exhale valve 36 used in the exhale port 24. The exhale valve 36 includes a UV-C emitting device 38 to sanitize air as it is exhaled by the user.

The fan 14 inserts into the fan insert receiver 28 so that the fan blades 34 are towards the inlet opening 30 of the fan insert receiver 28. The fan 14 and the fan insert receiver 28 are designed such that the fan 14 and fan inert receiver 28 interconnect to hold the fan 14 in place and so the shield 12 and fan 14 are hermitically sealed together. The fan 14 includes an air exit 40 that is positioned within the inside surface 22 of the shield 12. Fresh air is pulled into the inlet opening 30 by the fan blades when they are rotating and the fresh air is directed out of the air exit 40 and into the area covered by the inside surface 22 of the shield 12. The HEPA filter 32 is attached to the inlet opening 30 on the outside surface 20 of the shield 12 to filter the fresh air being pulled into the shield 12 by the fan 14. The battery 18 is connected to the shield 12 by a wire 42 that powers the fan 14 and the UV-C emitting device 38. The exhale valve 36 is activated when the user exhales. The exhale valve 36 is a one way valve that includes a moving seal 44 that opens when the user exhales waste air that is mostly carbon dioxide. Elastic straps or other adjustable straps can be attached to the strap ears 26 using the holes.

The user places the shield 12 over the user's face so that the inside surface 22 of the shield 12 covers the mouth and nose of the user. The shield 12 is rimmed by a face seal 46. The face seal 46 is a gel or air-filled material to cushion the interface between the face and the shield 12, so that there is a seal between the outside and the face to minimize unfiltered air from leaking into the system during deep inhalation. The user uses the strap ears 26 to utilize straps to hold the shield 12 against the user's face. The combination of the straps and the strap ears 26 is an attachment system to attach the shield 12 to the face of the user. The battery 18 is a power source connected to the fan 14 and UV-C emitting device 38 to activate the fan blades 34 and UV-C emitting device 38. The battery 18 can be a wearable collared battery that sits across the neck. The battery 18 can be 3 Ah capacity and theoretically last 8 hours or greater. There is a power switch on top of the battery 18 that activates the fan 14 and UV-C emitting device 38. When activated, the fan blades 34 begin to turn and pull outside fresh air through the HEPA filter 32 and into the area covered by the shield 12. The user breaths in the fresh air and exhales waste air through the exhale valve 36. The pressure from the exhaled air opens the moving seal 44 to allow the waste air to escape out of the shield 12. As the waste air leaves the shield 12 through the exhale valve 36, the waste air is sanitized by the UV-C emitting device 38. The fan 14 can have adjustable fan speeds to supply the constant air pressure at different flow rates.

While different embodiments of the invention have been described in detail herein, it will be appreciated by those skilled in the art that various modifications and alternatives to the embodiments could be developed in light of the overall teachings of the disclosure. Accordingly, the particular arrangements are illustrative only and are not limiting as to the scope of the invention that is to be given the full breadth of any and all equivalents thereof.

I claim:

1. A face shield adapted to fit over a face of a user to cover a nose and mouth of the user, comprising:
a shield having an inside surface and an outside surface, wherein said inside surface is adapted to fit over the nose and mouth of the user, said shield including at least one exhale port, said shield including at least one attachment system to fasten said shield to the face of the user, said shield including a fan insert receiver, said shield including an air inlet opening connected to said fan insert receiver as part of said shield to allow entrance of fresh air into an area covered by said inside surface of the shield;
a fan which attaches to said fan insert receiver, said fan including a motor and fan blades attached to said motor, said fan including an air exit connected to said air inlet opening of said fan insert receiver, said air exit of said fan positioned to dump air from said air inlet opening into said area covered by said inside surface of said shield, said fan positioned in said fan insert receiver so that said fan blades pull fresh air in from said air inlet opening to said air exit;
an air filter connected to said air inlet opening of said shield to filter air entering said shield;
an exhale valve connected to each of said exhale ports that allows waste air to exit said shield; and
a power source connected to said fan motor to run said fan.

2. The face shield of claim 1, wherein said power source is a battery.

3. The face shield of claim 1, wherein said shield is made of a nonporous material.

4. The face shield of claim 1, wherein said attachment system includes at least two strap ears with holes and an adjustable strap for each set of said two strap ears.

5. The face shield of claim 1, wherein said air filter is a HEPA filter.

6. The face shield of claim 1, wherein said exhale valve includes a UV-C emitting device to sanitize waste air exiting said shield that is exhaled by the user.

7. The face shield of claim 1, wherein said air inlet opening and fan are hermitically sealed together.

8. The face shield of claim 1, wherein said exhale valve includes a one way valve that includes a moving seal that opens when the user exhales waste air.

9. The face shield of claim 1, wherein said shield is rimmed by a face seal which is adapted to provide a seal between said shield and the user.

10. The face shield of claim 9, wherein said face seal is a gel filled material that is adapted to provide a cushion between the face of the user and said shield.

11. The face shield of claim 9, wherein said face seal is an air filled material that is adapted to provide a cushion between the face of the user and said shield.
